(19) United States
(12) Patent Application Publication
(10) Pub. No.: US 2026/0111676 A1
(43) Pub. Date: Apr. 23, 2026

(54) AUTOMATED RESPONSE SYSTEM

(71) Applicant: Leapfrog Studios Limited, London (GB)

(72) Inventors: Kieran Donaldson, London (GB); John Lusty, London (GB); Mikel Bober-Irizar, London (GB); Alba Navarro Rosales, London (GB)

(21) Appl. No.: 18/924,726

(22) Filed: Oct. 23, 2024

(51) Int. Cl. G06F 40/30; G06F 40/289; G06F 40/40

(52) U.S. Cl. CPC G06F 40/30; G06F 40/289; G06F 40/40

(57) ABSTRACT

There is described an automated response system for generating a response to a user input, the system comprising a first computer device, the first computer device comprising a processor for: receiving an input from a user; determining an intent of the input; based on the intent, determining a response from a pre-generated set of responses; and outputting the response to the user.

### FIELD OF THE DISCLOSURE

The present disclosure relates to an automated response system for generating responses to a user input.

### BACKGROUND

In many contexts, it is desirable to use a computer to provide automated responses to user inputs. For example, to handle inquiries to a telephone number, to provide realistic non playable characters (NPCs) in games, and—more generally—to provide a pleasant user experience in everyday situations where people need to interact with machines (e.g. to provide pleasant and efficient guided human-machine interactions).

Historically, interactions between users and response systems have relied on limiting the number of inputs available to a user. For example, an automated assistant may provide a user with three predetermined categories and ask this user to press a number on a keypad to select one of the categories. Such interactions are both unpleasant for a user and also inefficient since numerous inputs may be needed to reach a conclusion and since many queries will not fall neatly into the predetermined categories.

More recently, machine learning techniques such as large language models (LLMs) have been developed that enable computer devices to more accurately interpret a wide range of inputs. These models are able to provide a suitable response for a large range of (e.g. spoken) inputs; however, they suffer from a number of drawbacks.

Firstly, most computer devices lack the computational power to run high-end LLMs locally. Therefore, users often need to rely on cloud-based services (e.g. ChatGPT, Claude, etc.) to access these LLMs. This leads to increased latency, increased server costs, and reduced reliability and versatility. On this latter point, the use of cloud-based services typically requires an active network connection, which can cause a lack of functionality in situations where a user cannot or does not want to maintain such a connection.

Furthermore, even high-end LLMs are susceptible to hallucination, where LLMs generate plausible but incorrect information, as well as being vulnerable to prompt-injection attacks, which can lead to unintended or harmful outputs. Another concern is that for certain tasks, purely dynamic content generated by LLMs is undesirable. In scenarios requiring consistency, precision, or adherence to specific guidelines, relying on the unpredictable nature of LLM-generated responses can lead to errors, inconsistencies, or loss of control over the final output.

Due to the combination of the above factors, even high-end LLMs are liable to providing inaccurate, inappropriate, or otherwise undesirable responses.

Therefore, an improved method of generating responses to user queries is desired.

### SUMMARY

According to at least one aspect of the present disclosure, there is described an automated response system for generating a response to a user input, the system comprising a first computer device, the first computer device comprising a processor for: receiving an input from a user; determining an intent of the input; based on the intent, determining a response from a pre-generated set of responses; and outputting the response to the user.

Preferably, the processor and/or a processor of a second computer device is arranged to generate the pre-generated set of responses by providing a set of potential input phrases to a machine learning model.

Preferably, the intent is associated with one or more responses from the pre-generated set of responses.

Preferably, the processor is arranged to determine the intent using a machine learning model, preferably a machine learning model implemented on the first computer device.

Preferably, the processor is arranged to convert the input to a query and determine an intent of the query.

Preferably, converting the input to a query comprises one or more of: transcribing the input; checking for errors in the input; performing coherence resolution on the input to associate pronouns in the input with entities; and removing punctuation from the input.

Preferably, the first computer device comprises a communication interface for receiving the pre-generated set of responses from a second computer device.

Preferably, the second computer device comprises a more powerful processor than the first computer device, preferably a more powerful GPU.

Preferably, the first computer device comprises a consumer personal computer and/or a mobile device.

Preferably, the second computer device comprises a server with access to a high-end large language model.

Preferably, the processor is arranged to generate the pre-generated set of responses prior to the identifying of the pre-generated set of responses.

Preferably, the processor is arranged to filter and/or prune the pre-generated set of responses prior to the receiving of the input.

Preferably, the system comprises a second computer device, the second computer device being arranged to generate the pre-generated set of responses using a machine learning model, preferably a large language model, LLM.

Preferably, the second computer device is arranged to generate the pre-generated set of responses and then to transmit the pre-generated set of responses to the first computer device.

Preferably, the first computer device comprises a communication interface, the communication interface being arranged to: transmit the input and/or the intent to a second computer device, and receive a response from the second computer device, the response being selected by the second computer device from among the pre-generated set of responses; wherein the system comprises the second computer device, and the second computer device is arranged to generate and/or store the pre-generated set of responses.

Preferably, the processor and/or a processor of a second computer device is arranged to generate the pre-generated set of responses based on a set of potential input phrases.

Preferably, the processor is arranged to identify a set of potential input phrases, the set of potential input phrases being used to generate the pre-generated set of responses.

Preferably, the first computer device comprises a communication interface that is arranged to receive each of the pre-generated set of responses and the set of potential input phrases from a second computer device.

Preferably, the processor and/or a processor of a second computer device is arranged to generate the set of potential input phrases using a large language model.

Preferably, the processor is arranged to determine the intent of the input or the query by determining a similarity between the query and one or more potential input phrases from the set of potential input phrases, preferably using a machine learning model.

Preferably, determining the intent of the input or the query comprises one or more of: determining a most similar potential input phrase from the set of potential input phrases; determining one or more potential input phrases from the set of potential input phrases that exceed a similarity threshold; and determining a cluster of similar potential input phrases for the query.

Preferably, the processor is arranged to determine cosine similarity between the query and one or more potential input phrases.

Preferably, the processor is arranged to: determine that the query is not present in the set of potential input phrases; and based on the determination, transmit the query to a second computer device.

Preferably, the processor is arranged to: determine that a similarity between the query and a most similar potential input phrase of the set of potential input phrases is beneath a threshold value; and based on the determination, transmit the query to a second computer device.

Preferably, the processor and/or a processor of a second computer device is arranged to generate an updated pre-determined set of responses using the query.

Preferably, the processor and/or a processor of a second computer device is arranged to generate an updated pre-generated set of responses using the query in dependence on a human confirmation that the query is a relevant query.

Preferably, the processor and/or a processor of a second computer device is arranged to receive a response to the input from the second computer device and output the response to the user. Preferably, the response is not in the pre-generated set of responses.

Preferably, the processor is arranged to connect the user to an administrator (e.g. using a communication interface of the first computer device) based on the determination that the similarity is beneath a threshold value.

Preferably, the processor is arranged to: determine that the pre-generated set of responses does not contain a suitable response; and in response to the determination, providing a default response.

Preferably, the processor is arranged to: determine that the pre-generated set of responses does not contain a suitable response; transmit, to a second computer device, the input, the query and/or the intent; and receive a response from the second computer device.

Preferably, the processor is arranged to: determine a level of naturalness of a conversation with the user; and provide an alert if the level of naturalness falls beneath a predetermined threshold.

Preferably, the processor is arranged to: determine, based on the set of pre-generated responses, a set of available responses; and determine the response from this set of available responses.

Preferably, the set of available responses is dependent on one or more of: a state of the user; a history of previous actions of the user; and a history of inputs from the user.

Preferably, the set of available responses is determined so as to avoid repetition of a response.

Preferably, the set of available responses is determined so as to encourage the user to follow a predetermined conversation path.

Preferably, the processor is arranged to determine one or more characteristics of the input, and determine the intent and/or the response based on the characteristics.

Preferably, the characteristics include one or more of: an emotion of the input; a tone of the input; and a context or state of a user providing the input.

Preferably, the first computer device comprises a microphone for receiving an audio input. Preferably, the processor is arranged to identify a characteristic of the input based on this audio input.

Preferably, the processor is arranged to determine a persona for the response, and to determine the response based on the persona. Preferably, the persona is determined based on a feature of the input.

Preferably, the persona is associated with one or more of: an age, a nationality, an emotional range, and a response style.

Preferably, the processor is arranged to determine the response based on a previously provided response.

Preferably, the input comprises a voice input and wherein the processor is arranged to convert the input to a query comprises transcribing the input so as to generate a text query.

Preferably, determining the query comprises determining an error and/or a mistranscription in the input.

Preferably, the first computer device comprises an output for outputting the response as an audio response.

Preferably, the system is a system for emulating a video game character.

Preferably, the system is a system for guiding and/or assisting a human interaction.

According to another aspect of the present disclosure, there is described a response generation system for generating a pre-generated set of responses for an automated response system, the system comprising a second computer device, the second computer device comprising a processor for: determining a set of potential input phrases; determining, optionally using a large language model, a set of responses based on the potential input phrases; and transmitting one or more responses of this set of responses to a first computer device.

Preferably, the processor is arranged to determine the set of potential input phrases using a large language model.

Preferably, the processor is arranged to determine an expanded set of potential input phrases by determining phrases that are synonymous with and/or are potential errors of the potential input phrases.

Preferably, the processor is arranged to determine one or more personas, and determining the set of responses based on the personas.

Preferably, each persona is associated with one or more of: an age, a nationality, an emotional range, and a response style.

Preferably, the second computer device comprises a communication interface for receiving one or more supplementary input phrases from a first computer device and including these supplementary input phrases in the set of potential input phrases.

Preferably, the second computer device is arranged to transmit the one or more responses in response to a query from a first computer device, preferably wherein the query contains one or more of: an input phrase and an intent.

Preferably, the processor is arranged to select the one or more responses from the set of responses based on the input phrase and/or the intent.

According to another aspect of the present disclosure, there is described a system comprising each of the aforesaid automated response and response generation systems.

According to another aspect of the present disclosure, there is described a computer-implemented method of generating a response to an input, the method comprising: receiving an input from a user; determining an intent of the input; based on the intent, determining a response from a pre-generated set of responses; and outputting the response to the user.

Preferably, the pre-generated set of responses is generated before the receipt of the input, preferably at least an hour before, a day before, and/or a week before, the receipt of the input.

According to another aspect of the present disclosure, there is described a computer-implemented method of generating a pre-generated set of responses for an automated response system, the method being performed by a second computer device, the method comprising: determining a set of potential input phrases; determining, optionally using a large language model, a set of responses based on the potential input phrases; and transmitting this set of responses to a first computer device.

At least one aspect of the present disclosure relates to a voice-to-voice system that employs on-device processing for real-time conversational AI. Utilizing speech-to-text conversion, text classification through sentence similarity, and AI-generated speech, the system provides context-aware responses. The architecture includes offline generation of large labelled datasets using state-of-the-art cloud-based large language models (LLMs) and runtime filtering based on system state, emotional context and conversation history. This innovation ensures efficient operation on devices with limited compute resources, minimizing latency and eliminating server dependency.

According to at least one aspect of the present disclosure, there is provided an audio response system in which an audio input is analyzed in order to select and provide an appropriate response.

The systems and methods described herein provide efficient and accurate methods processing inputs and of communicating between devices. In particular, the use of a pre-generated set of responses prevents the need for lengthy (and large) communications between computer devices at the time of receiving a query from a user meaning that this query—and indeed a series of queries—can be efficiently addressed.

Furthermore, the systems and methods described herein provide an improvement in data security since the pre-generation of the responses enables the filtering of these responses so as to avoid the inadvertent leaking of secure information.

Furthermore, the system and methods described herein provide an improved method for computer-guided human interactions, where these systems efficiently enable a computer to guide a manual process being performed by a user of the system.

Any feature in one aspect of the disclosure may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure extends to methods and/or apparatus substantially as herein described with reference to the accompanying drawings.

The disclosure will now be described, by way of example, with reference to the accompanying drawings.

### DESCRIPTION OF THE FIGURES

FIG. 1 shows a computer device that can be used to implement an automated response system.

FIG. 2 shows a system comprising a plurality of computer devices that can be used to implement an automated response system.

FIGS. 3a and 3b show exemplary architectures for, respectively, pre-generating responses for user inputs and providing responses to user inputs based on a pre-generated set of responses.

FIG. 4 shows an exemplary mapping of an intent into a two-dimensional space.

FIG. 5 shows a method of pre-generating responses for potential user inputs.

FIG. 6 shows a method of providing responses to user inputs based on a pre-generated set of responses.

### DETAILED DESCRIPTION

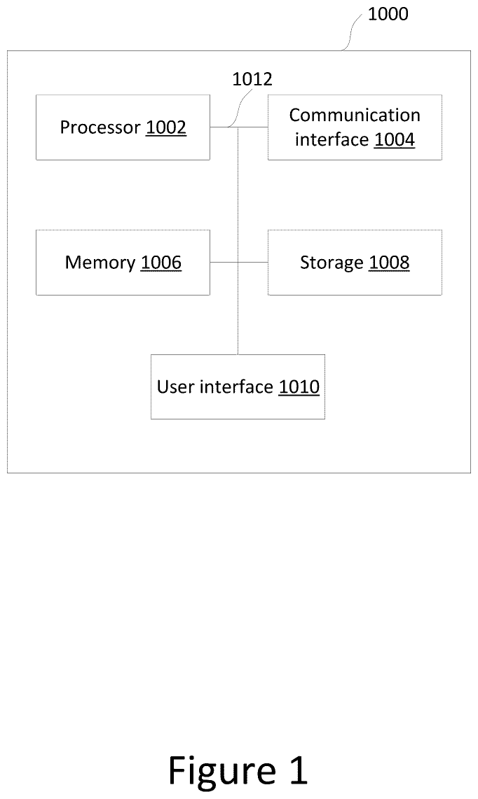

Referring to FIG. 1, the automated response system of the present disclosure is typically implemented using a computer device 1000. The computer device comprises one or more of: a processor 1002, a communication interface 1004, a memory 1006, storage 1008, and a user interface 1010. These components may be coupled to one another by a bus 1012.

The process 1002 executes instructions, including instructions stored in the memory 1006 and/or the storage 1008. The processor typically comprises one or more of a computer processing unit (CPU) and a graphical processing unit (GPU).

The communication interface 1004 is typically an Ethernet network adaptor coupling the bus 1012 to an Ethernet socket. The Ethernet socket is coupled to a network, such as the Internet. The communication interface facilitates communication between the computer device and further computer devices. It will be appreciated that various methods of facilitating such communication are known.

The memory 1006 stores instructions and other information for use by the processor 1002. The memory is the main memory of the computer device 1000. It usually comprises both Random Access Memory (RAM) and Read Only Memory (ROM).

The storage 1008 provides mass storage for the computer device 1000. In different implementations, the storage is an integral storage device in the form of a hard disk device, a flash memory or some other similar solid state memory device, or an array of such devices.

The user interface 1010 enables a user to interact with the computer device 1000 and may, for example, comprise a display, a touchscreen, or an input/output device such as a keyboard and a mouse.

A computer device as described may be used to implement various aspects of the automated response system. Equally, a plurality of computer devices may be used to implement different aspects of the automated response system, where these computer devices are able to communicate via respective communication interfaces.

Typically, the automated response system comprises a machine learning model (e.g. a large language model, LLM). This machine learning model may be trained using a first computer device, e.g. a device with a powerful GPU, before being transferred to a second computer device. More specifically, weights may be determined for the machine learning model using the first computer device and then these weights may be transferred to the (e.g. storage of) the second computer device. The second computer device is then able to receive inputs for the machine learning model and to provide suitable outputs even where the second computer model does not have the capability to train the machine learning model on its own.

A computer program product is provided that includes instructions for carrying out aspects of the method(s) described below. The computer program product is stored, at different stages, in any one of the memory 1006, storage device 1008 and a removable storage. The storage of the computer program product is non-transitory, except when instructions included in the computer program product are being executed by the CPU 1002, in which case the instructions are sometimes stored temporarily in the CPU or memory. It should also be noted that there may be provided removable storage that is removable from the computer device 1000, such that the computer program product may be held separately from the computer device from time to time. Different computer program products, or different aspects of a single overall computer program product, may be present on various computer devices that form a system that provides the automated response system.

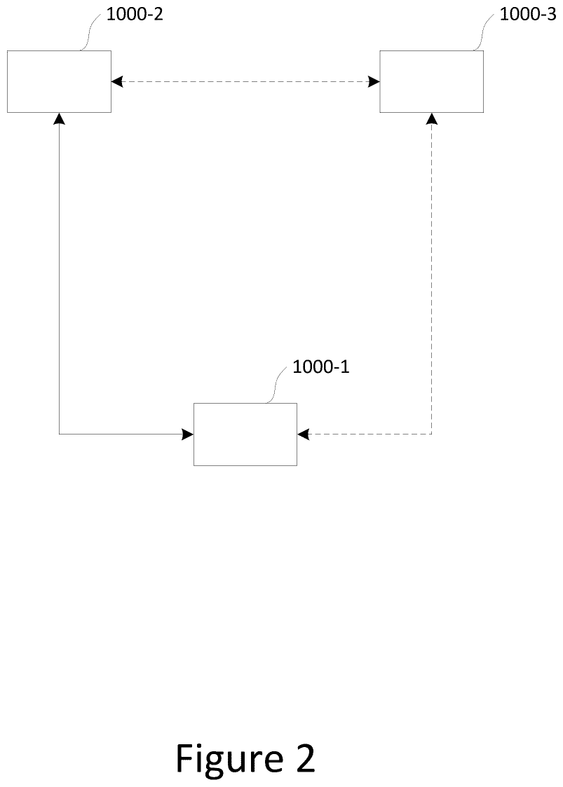

Referring to FIG. 2, there is shown a system comprising a plurality of computer devices 1000 1, 1000 2, 1000 3 that are arranged to communicate with each other via respective communication interfaces. The disclosures herein provide an automated response system that can provide a suitable output to a user of a first computer device 1000-1. The generation of this output may comprise communication between this first computer device and one or more of a second computer device 1000-2 and/or a third computer device 1000-3 (and/or one or more yet further computer devices). In particular, in order to generate the output, the first computer device may transmit a request to another computer device and receive the output from that other computer device. This may involve the first computer device being a consumer PC, this PC may then provide a query to a second computer device that is a more powerful device which implements a high-end LLM. The second computer device can then provide a suitable response for a given input and return this response to the PC.

The disclosures herein relate, at least in part, to an automated response system that can be provided locally, e.g. a system that can be provided on a single computer device so that a suitable response can be returned without this computer device communicating with a further device. This response system may receive a pre-generated set of responses from another (e.g. more capable) device before receiving an input and providing a response from this pre-generated set of responses. In some embodiments, the computer device is arranged to determine whether a suitable response can be generated locally and then, if a suitable response cannot be generated, to transmit a query to another (e.g. more capable) computer device in order to receive a suitable response.

In this regard, each of the second computer device 1000-2 and the third computer device 1000 3 may comprise different models and/or have different capabilities. For example, the second computer device may be arranged to generate responses for a first type of query and the third computer device may be arranged to generate responses for a second, different, type of query. The first computer device may then be able to communicate with a suitable other device depending on the type, or nature, of a user input.

The second computer device 1000-2 and the third computer device 1000-3 may be arranged to communicate between themselves, equally each of these devices may only communicate with the first computer device 1000-1.

### Pre-generation of Responses

According to at least one aspect of the present disclosure, there is described a method of pre-generating responses using a powerful, e.g. cloud-based, machine learning model so that these pre-generated responses can be transferred to a computer device and then be used to generate responses to user inputs locally.

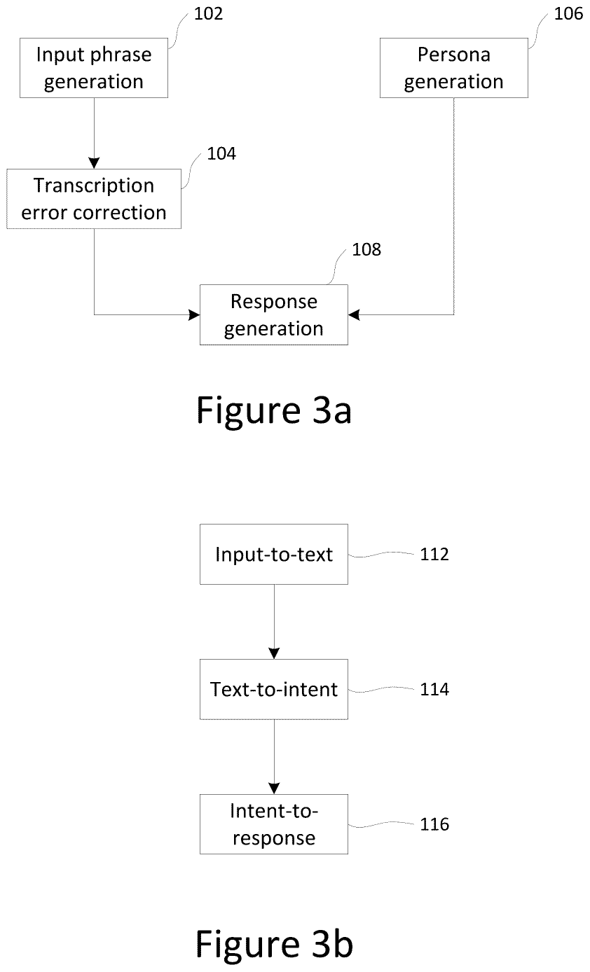

Referring to FIG. 3a, there is shown an exemplary generation architecture for pre-generating these responses. It will be appreciated that this architecture is purely exemplary and that practical implementations can use any combination of one or more of the described modules.

The exemplary architecture comprises an input phrase generation module 102, a transcription error correction module 104, a persona generation module 106, and a response generation module 108. One or more (or each) of these modules may be implemented using a machine learning model and/or a neural network.

Machine learning models—in particular large language models (LLMs)—and, for example, methods of training these models, are known in the art and so are not described in detail in this document.

The input phrase generation module 102 is arranged to generate a set of possible input phrases for which an output may be desired. For example, if the automated response system is arranged to be used to assist a user in searching for information in a database, the input phrase generation module may be used to generate possible phrases that might be uttered by that user.

Typically, the input phrase generation module is arranged to generate a set of (near-) synonymous phrases for a desired input. For example, a user may ask ‘where can I find X?’, but equally this user may ask ‘where is X? ’ or ‘X is in this section, isn't it?’. Each of these questions may be answered in a similar manner.

In some embodiments, the input phrase generation module is associated with emotion tags, where these tags indicate an emotion of a user providing an input. For example, the input phrases may include the phrases: ‘where is X?’ [friendly] and ‘I can't find X, where is it?’ [irritated]. As another example, an LLM that is told to generate ways of saying ‘yes’ including emotional tags may generate the outputs:
Absolutely! [enthusiastic]
Sure thing. [casual]
You got it. [confident]
Definitely. [confident]
No doubt. [confident]

The transcription error correction module 104 is arranged to generate common mistranscriptions for possible inputs. Typically this transcription error correction module is arranged to receive input phrases from the input phrase generation module 102 and to generate possible mistranscriptions for the input phrases generated by the input phrase generation module.

In various embodiments, the automated response system is arranged to respond to typed queries, to spoken queries, to physical queries, etc. and the possible mistranscriptions may be different for these various input types. For example, a user may wish to ask ‘how tall is John?’. For typed inputs, it is possible that the user may accidentally type ‘how tsll is John?’. For spoken inputs that are transcribed (e.g. using automated transcription), such an error is unlikely, but it is possible that a user may instead be mis-transcribed as saying ‘how tool is John?’.

The transcription error correction module 104 is arranged to generate such possible mistranscriptions. The transcription error module may be configured for a particular purpose, e.g. to generate spoken mistranscriptions or typed mistranscriptions. Equally, the transcription error correction module may be arranged to generate mistranscriptions for a range of different mediums.

As used herein, the term ‘mistranscription’ is typically used to denote any situation in which an input to a system does not match the intent of the user. With spoken inputs, a mistranscription generally occurs where a voice-to-text system has misunderstood (mis-transcribed) a spoken word of a user. With typed inputs, a mistranscription generally occurs where a user makes a typographic error (and so mis-transcribes their own thoughts).

It will be appreciated that the use of the transcription error correction module 104 is exemplary and that the input phrases may be fed directly into the response generation module with the possibility of mistranscriptions being handled elsewhere (e.g. before inputs are provided to a trained model at the time of use).

The persona generation module 106 is arranged to define one or more personas for which responses are to be generated. For example, the persona generation module may define personas with a given age, nationality, emotional range, or response style. Examples of personas are:

You are a calm adult from Ireland. Be brief, usually giving 2 to 6 word answers.

You are an angry teenager from the Midwest of America. Be hesitant, correcting yourself, restarting partial sentences.

In use, these personas can be used to provide personalized, and near-unique, responses to different users. This may help to provide—for example—relatively brief and to-the-point responses to experienced users who want quick answers and rapid progress while providing comparatively long and reassuring answers to less experienced users or, e.g. the elderly, who may be in less of a rush but would appreciate a more guided experience.

The personas are designed to mimic a range of user interactions and cover various emotional states. In some embodiments, the procedural prompts used to generate personas may follow the format: “You are a [emotion] [age] from [country] who speaks [style] and likes to ask [type] questions. ” But it will be appreciated that various inputs are possible to generate a persona including one or more of: emotion, age, country, speaking style, questioning type, and temperament.

Personas are typically generated ahead-of-time to broaden conversation datasets.

These personas are typically associated with a set of parameters, where the aforementioned inputs (such as age, nationality, etc.) are used to determine values for these parameters.

It will be appreciated that the use of personas is optional and that the response system may be provided with only a single persona.

The response generation module 108 is arranged to receive the possible inputs (e.g. following the generation of input phrases at the input phrase generation module 102 and/or the generation of possible mistranscriptions using the transcription error correction module) and any personas generated using the persona generation module 106. The response generation module is arranged to generate outputs for each of the provided inputs and personas so as to output a dataset that relates possible inputs to suitable outputs for each persona.

In some embodiments, hundreds of thousands (or more) potential input phrases are provided to the response generation module 108 leading to the generation of a comparable, or greater, number of responses. Using the personas, a number of response (e.g. tens, hundreds, or thousands) of responses may be generated for each possible input, which provides a hugely versatile set of pre-generated responses.

However, typically, the response generation module 108 is arranged to provide a number of responses that is less than (e.g. less than one-tenth of, or less than one-hundredth of) the number of potential input phrases. To enable this, a plurality of input phrases can be mapped to a single response or a single set of responses. This enables the automated response system to respond to a wide range of inputs without needing to store an impracticably large set of responses.

Each of these modules is typically implemented on a powerful computer device, e.g. the second computer device 1000-2 that may use a high end LLM to generate the outputs.

Therefore, the exemplary architecture enables the generation of a wide range of suitable responses for a set of given input phrases. This generated dataset can then be transferred to the (less powerful) first computer device 1000-1 where it can be used to provide outputs to users locally.

As used herein, a ‘high end’ LLM typically comprises an LLM that comprises more than 8 billion parameters and/or that has a size of at least 16GB. Such LLMs are typically impractical to run on personal computing devices.

The outputs provided are then more suitable and, e.g. realistic, than would be possible if responses were generated purely using the first computer device 1000-1 (e.g. than would be possible using a less powerful LLM on the first computer device).

This type of automated response system is particularly suitable for situations where a limited number of types of input phrases may be used. For example, in a situation where a user may ask ‘where do I find X?’ in a number of different ways, but where the user is unlikely to ask ‘what is the meaning of life?’. In such situations, the powerful input-output pairings generated by a high end LLM can be leveraged by identifying potential input phrases ahead of time, generating responses for these potential input phrases, and then pre-generating and outputting the input-output pairings for use by a computer device that does not (or cannot) access the high end LLM.

These potential input phrases may be based on administrator inputs and/or on previously received inputs. Specifically, when the automated response system is initiated, an initial set of input phrases may be provided to the input phrase generation module 102 by an administrator and the input phrase generation module may then generate a range of possible similar or synonymous phrases that form possible inputs of the automated response system. The automated response system may then be continuously updated while it is being used. For example, if the automated response system on the first computer device 1000-1 receives an input of an unknown type or an input that cannot be associated with an output, then this input may be transmitted to the input phrase generation module 102 (on the second computer device 1000-2) and an output may be generated for this input and for similar inputs. This output may then be communicated to the first computer device. The output may then be provided to the user providing the unknown input (where this may require the user waiting for an extended period of time to receive the output) and/or the output may then be rapidly provided to future users providing a similar input. Where the set of potential input phrases is updated, the updates may be screened by an administrator so that administrator approval is required for a phrase to be added to the set of potential input phrases.

As described above, the input phrases may be associated with emotional tags. More generally, the input phrases may be associated with one or more characteristics such as: an emotion; a tone; a context, e.g. a location or a time; a user experience; a number of previously generated responses; an urgency; a priority level; etc. Each characteristic may be associated with a different tag. The same input phrases may link to different outputs based on these characteristics so that a question asked in a frustrated or exasperated tone receives a different response to a question asked in an uncertain tone.

Typically, the pre-generated responses are arranged to be provided as audio responses (e.g. as a voice). Equally, the responses may comprise a video component or the responses may be purely textural. The responses may be converted into a desired format prior to transmission to the first computing device 1000-1. For example, the second computer device 1000-2 and/or the third computer device 1000-3 may be used to convert a textual response into an audio response. This enables the use of high end machine learning models that are able to generate audio (or video) with appropriate inflections/emotions. Equally, this may enable a large database of audio recordings to be accessed to generate the audio.

Therefore, the ‘pre-generated outputs’ referred to throughout this document may comprise outputs of any format. Equally, the pre-generated outputs may be stored in text and then converted to a desired format at the time of a request being received, where this approach generally provides efficient storage of responses so that these responses can be stored on personal computers with limited storage space.

The modules described above may be provided using a variety of machine learning models, in particular large language models. For example, these modules may use OpenAI's ChatGPT or Anthropic's Claude. Typically, these models require substantial computing resources (e.g. operating these models may require upwards of 100 GB of RAM).

The size of the set of pre-generated responses may be altered based on an intended use of these responses. For example, mobile devices typically have less storage space than stationary personal computers and so a smaller set of responses may be generated for, or provided to, mobile devices. This may involve altering the pre-generated set of responses to relate to a smaller number of personas or to provide responses to only a limited set of potential input phrases.

### Response Determination

As described above, the automated response system typically relies on pre-generated responses in order to provide a response to a range of potential inputs.

In some embodiments, the automated response system comprises an algorithmic response system where each potential input is linked directly to a single response or to a group of possible responses. In some embodiments, the automated response system comprises a machine learning model, e.g. a LLM, where this machine learning model provides a suitable output for a given input, the suitable output being obtained from the pre-generated outputs.

Typically, the pre-generated outputs are generated using a high end LLM (e.g. that operates on a powerful computing device). The edge node (e.g. the computer device providing the response to a user) may then run a comparatively low end LLM or other machine learning model in order to select a suitable response from the pre-generated responses. This combination of a high end machine learning model that pre-generates responses for a limited number of inputs and a low end machine learning model that selects a suitable response from the pre-generated responses to respond to a given input provides a sophisticated, accurate, and efficient, automated response system that can rapidly provide responses using a consumer-level device.

Referring to FIG. 3b, there is shown an exemplary response architecture for use on the first computer device 1000-1, e.g. on a local device that is arranged to provide a response to a user input.

More specifically, the pre-generated set of responses that is generated on the second computer device is transferred to the first computer device and then, at a later time, a user of the first computer device is able to input a query using the user interface and to obtain a suitable response from the first computer device (this response being selected from among the pre-generated set of responses).

The exemplary response architecture comprises an input-to-text module 112, a text-to-intent module 114, and an intent-to-response module 116.

The input-to-text module 112 is arranged to receive an input, e.g. a speech input, from a user and to transcribe this input into a textual query. It will be appreciated that in various implementations, the input may be received in various forms (e.g. as speech, as text, or as a gesture). In general, the response architecture comprises an input module that is arranged to receive an input from the user and to convert this into a useable form (e.g. text) for later processing. This may, for example, comprise lightweight normalization such as removing punctuation, converting text to lowercase, etc. This may, for example, comprise translating text to a specific language, e.g. English. This may comprise, for example, coreference resolution where any references to previously mentioned entities are resolved. For example, where an input contains ‘he’ or ‘she’, the speech-to-text module may analyze previously received inputs in order to associate this pronoun with a particular person that has been previously mentioned. It will be appreciated that various other processing operations may be implemented to process an input.

The input-to-text module 112 may comprise a mistranscription or an error checking component (e.g. where the input is text, the input module may comprise a typo-checking component). This error checking component may be used instead of, or may be used as well as, the transcription error correction module 104 in the generation architecture. That is, any errors may be accounted for during the pre-generation of the responses, during the processing of an input, or at both of these stages (e.g. for redundancy).

The input-to-text module 112 may also be arranged to extract one or more characteristics of the input, such as an emotion, a tone or a context. These characteristics may be associated with the text of the input and thereafter used to identify an appropriate response. This extraction of characteristics may use a machine learning model or may use an algorithmic approach (e.g. where an emotion is determined based on a volume of an input). Equally, a user may be able to provide an explicit indication of a characteristic (e.g. a typed or spoken input to indicate this characteristic).

In some embodiments, the input-to-text 112 module comprises a neural network, for example the Whisper model used by OpenAI. In some embodiments, the received text is encoded, e.g. using a phonetic algorithm such as Double Metaphone.

The text output by the input-to-text module 112 is hereafter referred to as a ‘query’, where this query is used to identify an appropriate response. The ‘query’ also contains any characteristics associated with the text.

The text-to-intent module 114 is arranged to infer the meaning of the query provided by the input-to-text module 112. Inferring the ‘intent’ typically comprises associating the query with one or more input phrases for which there is a corresponding response in the pre-generated set of responses.

The text-to-intent module 114 may comprise or may query a neural network and/or a (e.g. fine-tuned) sentence-similarity model that maps into a vector space both the received (and converted) input and the potential input phrases used to generate the pre-generated responses.

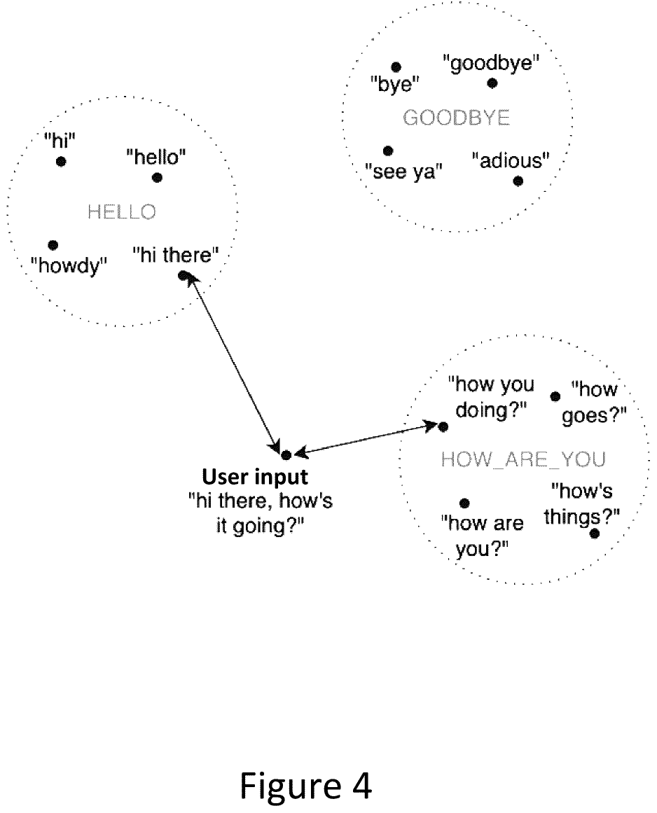

These coordinates may be termed ‘embedding’. Sentences with similar meaning have similar vectors/embeddings in the vector space so that the response architecture is able to identify similar sentences based on these sentences forming groupings or clusters in this vector space. An example of this mapping that shows a two-dimensional space is shown in FIG. 4 where it can be seen that the initial input “hi there, how's it going” can be separated into query phrases (e.g. clauses) and then mapped into a vector space to identify that this input contains a clause that relates to a ‘hello’ grouping and a clause that relates to a ‘how are you’ grouping.

It will be appreciated that the use of a two-dimensional space is purely exemplary and that in practice a much larger number of dimensions is typically used (e.g. a 768-dimensional space may be used).

To find the closest potential input phrase to the query, a nearest neighbour search may be used. For example, the text-to-intent module 114 may compare the query to each of the potential input phrases by calculating a cosine similarity, where the closest potential input phrase (the nearest neighbour) is then determined as the potential input phrase with the highest cosine similarity. The cosine similarity can be determined as:
cosine similarity(A, B)=(A·B)/|(|A|)∥(|B|)|

Where A is the embedding of a query and B is the embedding of an input phrase from the set of potential input phrases.

It will be appreciated that cosine similarity is merely an exemplary measure of similarity and that various other measures of similarity may be used.

While, typically, the text-to-intent module 114 is arranged to identify the closest potential input phrase to the query, in some embodiments the text-to-intent module is instead arranged to identify (e.g. randomly or based on a previous action or response) one of a plurality of potential input phrases that exceeds a threshold similarity. Therefore, if a user repeatedly asks a similar question (e.g. in different circumstances) they are able to receive different suitable responses. For example, a user that says ‘hello’ to two different response systems during an interaction may receive two different responses from the ‘hello’ grouping. This provides an improved user experience as well as a more versatile system. On this latter point, if the user asks the same question twice then they can receive two different valid responses and they may be better able to interpret one of these responses.

The use of this similarity model is shown in FIG. 4, which shows that the query ‘hi there’ can be closely (e.g. exactly) mapped to the potential input phrase ‘hi there’ and that the query ‘how's it going’ can be closely mapped to the potential input phrase ‘how you doing?’.

It will be appreciated that a suitable response can be provided if the query is an exact match for a potential input phrase, but equally the use of the similarity enables a suitable response to be determined for queries that are not an exact match for any potential input phrase as long as these queries are similar to (in meaning) a potential input phrase. Therefore, the pre-generated set of responses can be generated based on a limited number of potential input phrases while being useable for a much larger set of input phrases that contains phrases that are similar to the potential input phrases.

In some embodiments, the identification of the potential input phrase to match to the query is based on a further factor, such as a state of a user, a previous response, or an action by an administrator. In particular, certain potential input phrases that might otherwise be selected as the matching potential input phrase may be disabled in order to avoid repetition of a previous conversation and/or to force the user down a desired path. In some embodiments, certain potential input phrases are only unlocked following the performance of an activation action by a user. For example, a user may need to provide login information or a password in order to access certain functionality of the automated response system. In a simple example, a user that is not logged in may only be able to receive generic responses, whereas a user that is logged in is able to receive responses that include a user's name.

Similarly, in some embodiments the identification of the potential input phrase to match to the query is based on one or more filters that may be defined by an administrator of the response system in order to force a user down a desired path (e.g. if the user has a certain state, the filters may force the text-to-intent module to select an intent from a limited set of intents).

Where the potential input phrases are associated with characteristics (e.g. a tone or an emotion), the identification of the potential input phrase to match to the query may also be dependent on these characteristics (where the characteristics may also be a factor within the mapping of the query to a location in the space and a factor within the mapping of the potential input phrases in the space).

The potential input phrase that is matched to the query is hereafter termed as the ‘intent’ of a user, with this intent being the intent determined by the text-to-intent module 114.

The intent-to-response module 116 is arranged to map the query to a response based on the identification of the intent of the user. The characteristics of the input (e.g. the emotion or tone) may be accounted for during this step. Equally, as described above, these characteristics may be determined during the determination of the intent. Similarly, previous actions that have occurred in a conversation may be considered by the intent-to-response module in order to map an intent to a response or equally previous actions may be considered previously during the determination of the intent.

The intent-to-response module thereby determines an appropriate response from the set of pre-generated responses based on an input provided by a user. In some embodiments, this response may then be converted into a suitable format (e.g. a stored text response may be converted into an audio format).

In some embodiments, one or more of (or all of) the input-to-text module 112, the text-to-intent module 114, and/or the intent-to-response module 116 are implemented using a machine learning model. For example, the machine learning model may receive as an input one or more of: an input phrase provided by a user, an input emotion associated with the phrase, a context of the user (e.g. a state of the user), a history of the user (e.g. a list of previous actions taken by the user), and the machine learning model may then identify and provide a suitable response from among the pre-generated responses. Equally, one or more of these modules may be implemented algorithmically (e.g. the mapping of an intent to a response may be based on precise links between intents and responses). Typically, these modules use a machine learning model at least because a machine learning model typically provides a larger variety of responses to similar inputs than an algorithmic model so as to make conversations feel more natural to a user.

### Methods of Generation and Response Determination

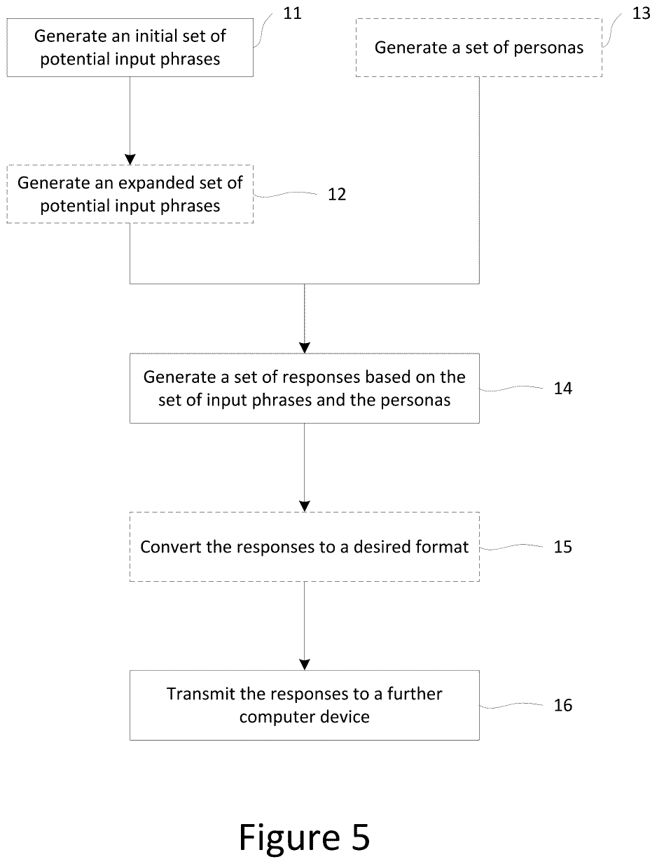

Referring to FIG. 5, there is described a method of generating a set of responses based on a provided set of potential input phrases. This method is typically used with the generation architecture of FIG. 3a to generate a set of pre-generated responses at the second computer device 1000-2. The method typically comprises a computer-implemented method carried out by that second computer device.

In a first step 11, an initial set of potential input phrases is generated. This set of potential inputs may be generated based on a user input (e.g. by an administrator of the automated response system). Equally, this set of potential inputs may be generated based on inputs received by the automated response system. In particular, the LLM used to generate the responses may be continuously retrained based on the inputs being received by the generation architecture upon deployment.

In some embodiments, the set of potential input phrases is generated (or supplemented) based on real inputs provided to the automated response system during use of this system. More specifically, input phrases provided by (real) users may be transmitted from one or more first computer devices 1000-1 to the second computer device 1000-2 and used to supplement the set of potential input phrases. The second computer device may then generate an updated set of responses (or an updated mapping of potential input phrases to responses) based on this supplemented set of potential input phrases. Typically, the real inputs are transmitted to the second computer device 1000-2 asynchronously and/or periodically so that an updated set of pre-generated responses. This method of supplementing the set of potential input phrases enables the system to be continuously improved over the course of its life.

This generation of the set of potential input phrases typically comprises the generation of textual phrases as well as, optionally, the generation of characteristics associated with these phrases (e.g. a tone, an emotion, a context, etc.). In some embodiments, the generation of the potential input phrases comprises generating different phrases that have the same text but different characteristics—for example, a plurality of inputs with the same words may each be associated with different emotions or tones (to reflect, for example, whether a user is in a good mood, or is irritated, or is being sarcastic). In a simple example, a user that is saying ‘I need help’ may be provided a different response depending on whether they are saying this in a friendly tone or an angry tone. Equally, these characteristics may be separated from the textual phrases and these characteristics may be used later on. For example, the characteristics may be accounted for during the response generation in order to generate, for example, the same phrase with a variety of different emotional tones.

In a second (optional) step 12, an expanded set of potential input phrases is generated using the input phrase generation module 102 and the transcription error correction module 104. In particular, synonymous phrases and potentially mis-transcribed or mistyped phrases may be determined and added to the set of potential input phrases.

In a third (optional) step 13, that may occur before, at the same time as, or after, the generation of the potential input phrases, a set of personas is generated using the persona generation module 106. This typically comprises providing a set of inputs, e.g. age, nationality, personality, verbosity, to a machine learning model in order to generate each persona. Typically, each persona is associated with a set of parameters, where the provided inputs are used to define the values for the various parameters.

In a fourth step 14, the set of potential input phrases and any personas are provided to the response generation module 108, which is typically a LLM, and these input parameters are used to generate a set of responses.

In a fifth, optional, step 15, the pre-generated responses are converted to a desired format. For example, textual responses may be converted to an audio format where this may involve the use of a machine learning model or of a set of available recordings.

The responses, following conversion if a conversion is implemented, then form a pre-generated set of responses.

In a sixth step 16, the pre-generated responses are transmitted to another computer device, e.g. the first computer device 1000-1.

This transmission occurs at a first time so that the pre-generated responses can be used to respond to inputs at a second, later, time. The sixth step 16 may also comprise transmitting to the other computer device the potential input phrases that have been used to generate the pre-generated responses and/or transmitting the associations between the potential input phrases and the pre-generated responses (so that the other computer device can rapidly identify a suitable pre-generated response when given an input phrase from the potential input phrases).

This method has described the pre-generated responses being generated on the second computer device 1000-2 before being transmitted to the first computer device 1000-1 where this enables the comparatively less capable first computer device to benefit from the capabilities of the second computer device. Equally, the pre-generated responses may be generated on the first computer device, where the pre-generation of these responses may enable the first computer device to generate the responses over a large amount of time before providing a suitable response quickly to a user at the time of a query.

In some embodiments, e.g. before or after the transmission of the pre-generated set of responses, the pre-generated set of responses is modified, e.g. in order to sanitize the pre-generated set of responses to remove inappropriate or incorrect responses from the pre-generated set of responses. In some embodiments, different sanitized sets of responses may be transmitted to different devices (e.g. where different sanitized sets may be suitable for different audiences, such as children and adults). The modifications may be used as feedback to retrain the LLM that is used to generate the pre-generated set of responses.

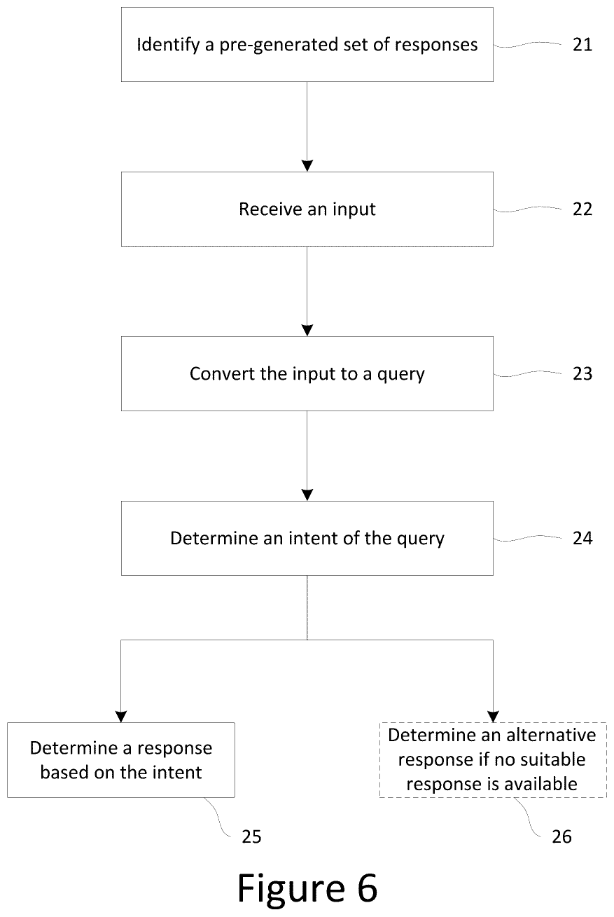

In this regard, referring to FIG. 6, there is described a method of generating a response based on a pre-generated set of responses and an input. This method is typically performed by a computer device such as the first computer device 1000-1.

In a first step 21, the computer device identifies a pre-generated set of responses. This typically comprises receiving the pre-generated set of responses from a further computer device. Equally, this may comprise the computer device itself generating the pre-generated set of responses prior to the initiation of the method of FIG. 6 and then identifying this pre-generated set of responses.

The first step typically further comprises identifying a step of potential input phrases where each input phrase in the set of potential input phrases is associated with a response in the pre-generated set of responses. The first step may further comprise identifying the associations between the potential input phrases and the responses.

In a second step 22, the computer device receives an input. This input may be in any form, e.g. text, speech, or gestures. Typically, the input comprises a speech input.

In a third step 23, the computer device converts the input to a textual input (e.g. using the input-to-text module 112). This may comprise transcribing a speech input. The third step may further comprise error-checking the input, e.g. to identify and mistranscriptions or typos as well as resolving coreferences and processing the textural input to remove punctuation etc. This converted and processed input may be considered to be a query so that the third step may involve determining a query from the input.

In a fourth step 24, the computer device determines an intent of the query using the text-to-intent module 114. This typically comprises comparing the query to a set of potential input phrases and identifying a closest potential input phrase to the query (or identifying one or more potential input phrases that exceeds threshold similarity value when compared to the intent).

In some embodiments, determining the intent comprises determining a cluster for the query. More specifically, the computer device (either the second computer device that generates the pre-generated set of answers or the first computer device) may sort each of the potential input phrases into clusters based on a similarity of these input phrases. In some embodiments, this may result in each potential input phrase being located in a different cluster, but typically one or more clusters contains a plurality of potential input phrases. The determination of the intent may then comprise determining a cluster for a query and then determining the intent based on this cluster. This may involve determining an intent that is an intent for every input phrase in the cluster.

Equally, this may comprise determining the intent as being one of the input phrases in the cluster (e.g. the intent may be determined by selecting a random input phrase from the determined cluster).

In a fifth step 25, the computer device determines a suitable response based on the determined intent using the intent-to-response module 116. This typically comprises providing an input to a machine learning model that includes one or more of: the intent, a characteristic (e.g. a tone or context) of the intent, and a history of actions, in order to receive an output that is a suitable response. It will be appreciated that other (e.g. algorithmic) methods of processing inputs and of matching these input to suitable responses are possible. For example, keywords may be extracted from the inputs and then conditional logic may be used to identify a suitable response for a given set of extracted keywords.

In some embodiments, the computer device is arranged to generate a set of available responses, where this set of available responses depends on, for example, the context of a user. In particular, the available responses may depend on information received by, or known by, the user providing the input. For example, the available responses may depend on a permissions level of the user.

In an optional sixth step 26, if the computer device determines that it is not possible to provide a suitable response, the computer device may provide an ‘alternative’ response. In this regard, the computer device may determine that the query does not exceed a similarity threshold for any of the set of potential input phrases and/or the computer and so there is not a suitable response in the pre-generated set of responses that can be returned.

In this eventuality, the computer device may provide a default response or answer such as ‘I do not know’ or ‘please ask a different question’. Equally, the computer device may respond by suggesting a question for the user to ask.

Typically, the default response is selected from a set of default responses so that a user repeatedly providing inputs without a suitable response receives a range of different default responses.

The set of default responses may contain responses of varying priority, where a priority value is determined based on the input and then a suitable default response is selected based on this priority value. The priority value may be determined based on a number of previous (e.g. irrelevant) inputs provided by a user so that a user that is repeatedly asking irrelevant questions is at first steered gently towards more relevant questions and then is eventually firmly steered towards more relevant questions. Equally, the priority value may be determined based on a feature of the input, such as a keyword being identified in the input.

Therefore, for example, default responses with a low priority value may be provided to confused users and default responses with a high priority value may be provided to a user that is providing profane or threatening inputs.

In some embodiments, the computer device may transmit a query to a further computer device (e.g. the second computer device 1000-2) in order to identify a suitable answer or to flag up a potentially problematic input. Such a transmission typically requires an increased response time, so the computer device may return a stalling answer, e.g. ‘let me think about that’, to cover the time required to retrieve the suitable answer from the other computer device.

Following the sixth step 26, the input phrase that led to the lack of an answer may be added to the set of initial input phrases and the method of FIG. 5 may then be repeated to generate a suitable response for this input phrase. This may involve the first computer device sending a transmission to the second computer device identifying this input phrase.

Even if a suitable answer has been determined, information relating to a query or an intent may be transmitted to the second computer device 1000-2. In particular, if an input phrase provided by a user is not present in the list of potential input phrases, but an intent can still be identified for this input phrase, then this input phrase or this intent may be transmitted to the second computer device. In a practical example, the set of potential input phrases may include: “agreed”, “fine”, and “ok” with each of these phrases being associated with a ‘user agrees’ intent. A user may then provide an input that is “alright” and this user input may be mapped to the same intent of ‘user agrees’. This user input of ‘alright’ may then be added to the set of potential input phrases and the intent of this user input may then be confirmed. This may involve using a machine learning model to determine whether the intent is sufficiently similar to an existing cluster of potential input phrases to be added to this cluster.

More specifically, the first computer device 1000-1 may be used to make an initial determination of the intent of this user input phrase and to provide a suitable response from the set of pre-generated responses. The user input phrase of ‘alright’ may then be transmitted to the second computer device 1000-2 and added to the set of potential input phrases so that the second computer device can confirm (or not) that the classification made by the first computer device is correct. Then, if this same user input phrase is provided by another user in the future, the first computer device will be able to provide a suitable response. In some situations, the (more powerful) second computer device may map the user input phrase to a different intent than the first computer device.

In some embodiments, if an intent cannot be sorted into an existing cluster of potential input phrases, then this intent is flagged for review. For example, a human may be required to check the intent in order to ensure that it is a suitable query (e.g. it is not a slur or an inappropriate input) and then the intent may be admitted into the set of potential input phrases based on a human confirmation.

In some embodiments, the automated response system may be arranged to connect a user to an administrator and/or a human based on the automated response system being unable to determine a suitable response to an input phrase (and/or to a plurality of input phrases).

Typically, the first computer device 1000-1 is arranged to transmit to the second computer device 1000-2, e.g. periodically or infrequently, input phrases for which a suitable response could not be found in the set of pre-generated responses so that the second computer device can regenerate the pre-generated responses. Equally, in embodiments where the pre-generated responses are generated on the first computer device, the first computer device may be arranged to periodically regenerate the pre-generated responses.

Typically, the method incorporates an additional layer of quality control by utilizing a large LLM to batch process user inputs and system responses. These batched conversations can then be sent to a further device, e.g. the second computer device 1000-2 for processing and analysis. This further computer device may employ an LLM to continuously monitor and evaluate samples of conversations, identifying any anomalies or errors in near real-time. The further computer device may be arranged to measure conversation coherence and naturalness, flagging interactions that may require administrative attention. This proactive monitoring enables administrators to quickly patch the dataset, ensuring ongoing improvements in system performance and conversational accuracy.

Determining the conversation ‘naturalness’ may be performed by a machine learning model so that no human oversight is required to analyze the performance of the various computer devices.

The methods above have primarily been described with reference to the first computer device 1000-1 locally determining the suitable response. It will be appreciated that the response may be determined remotely, e.g. by the second computer device 1000-2 or the third computer device 1000-3 while still benefiting from the use of a pre-generated set of responses.

In this regard, whether the response is generated locally or remotely, the methods disclosed herein provide a number of advantages over existing automated response systems. These advantages include: decreased latency; increased reliability (since the responses can be determined locally); increased privacy (as user inputs are not required to be transmitted); enhanced security and control over outputs as well as improved accuracy since the pre-generated dataset can be sanitized before use.

### Use Cases

Various use cases are possible for the disclosed methods, including (but not limited to):

The disclosed methods enable the provision of enhanced virtual personal assistants with natural and intelligent conversational capabilities, improving user interactions. The system can handle complex, multi-turn conversations, offering a more engaging and useful assistant experience.

The disclosed methods enable the provision of improved customer service systems with automated customer service interactions, by providing accurate and context-aware responses to user queries. By understanding the context and emotional tone of the conversation, the system can deliver more satisfactory customer experiences.

The disclosed methods enable the provision of improvements for characters in entertainment and gaming by delivering immersive and interactive dialogue experiences in gaming and entertainment applications, adapting to user inputs in real-time.

The disclosed methods more generally enable the provision of improved methods of computer-guided human interactions where the automated response system is able to provide suitable responses to assist human users in a range of tasks, such as searching for information, performing practical tasks (e.g. undertaking repairs or controlling systems), processing or analyzing data, etc.

In a simple example scenario, in a gaming environment the system may be used to enhance NPC (non-playable character) interactions. For instance, a player might say, “Hey, what's next?” The disclosed response system can process this input, consider a game state (e.g., whether the NPC has a certain key), and respond with a contextually appropriate line, such as “You need to take this silver key and keep it safe” providing a dynamic and immersive gaming experience. The system can also adjust NPC responses based on the player's past interactions and sentiment in the player's input, creating a more personalized and engaging experience. For example, if the user returns to the NPC, then the NPC might respond with: “is the silver key still safe? Have you found the silver door?”.

In a similar scenario, the player may ask another NPC ‘how do I open this door?’. The player could ask this in different ways: ‘the door is locked, what do i do?’, ‘please help open the door’, ‘how am i meant to open this door in front of me?’, ‘door closed. What now?’, etc.

With the disclosed system, the NPC's response can be near instantaneous and they can respond differently depending on if the player has already picked up the key, say, or if the player has already asked this question, or the relationship between the player and the NPC. For example, the NPC may say: “you need to select the key from your inventory” or the NPC may say “to open the door you must find the silver key”.

### Practical Example

A more detailed practical example is explained below from a video game where the player uses their voice to communicate with a non-player character. The player uses a microphone to provide inputs and can hear the NPC's voice via a headset or speakers.

It will be appreciated that the provided example is an example that is provided because the context of a computer game is suitable for readily describing a range of advantages of the system. As will be clear from the above description, the disclosed response system has a range of other uses.

With this example, data is prepared ahead of time using an authoring tool. This data is used in conjunction with LLM conversation data. The data comprises information about one or more events, where each event has game state ‘pre-conditions’ that must be met for this event to be available. The player is able to provide inputs (e.g. voice inputs) in order to interact with NPCs and in order to cause updates to the game state that may alter the available events.

In order to generate suitable responses, the game data is used alongside persona information relating to the NPCs and potential input phrases (including homophones).

This data is used to calculate embeddings so that user inputs can be converted into intents that can be used to determine suitable responses to these inputs. These embeddings are calculated for each player example using the fine-tuned sentence similarity model.

In this example, in order to generate responses, the following information may be provided for a persona of the NPC:

“In this interaction, you are Amy, the chief engineer aboard an old freighter-turned-survival ship, the Nova, drifting on the vast ocean after a devastating solar micronova. Years ago, the sun unleashed a powerful burst of energy, causing a planetary catastrophe. The electromagnetic surge from the micronova knocked out most of the world's electronics, fried communication systems, and left entire regions in chaos. With no technology left to rely on, survival became a matter of resourcefulness.

Your ship, once a humble cargo freighter, was hastily retrofitted to be a floating sanctuary for a small community. It has been 30 years since you've set out, sailing through unpredictable waters in search of a safe harbor. The ocean is now a graveyard of abandoned vessels, and the few survivors like you navigate the seas with nothing more than basic mechanical equipment and your knowledge of old-world engineering.

I'm on another ship, the Vanguard, also trying to survive after the disaster. We're separated by miles of open water, our only connection a rusty, barely functional radio. My crew has been ravaged by illness and hardship, and we're struggling to keep our ship running.

As the chief engineer, your job is to keep your ship's engines operational, manage the dwindling fuel reserves, and ensure the water desalination system remains functional. The delicate balance of keeping the ship afloat and the community alive rests on your shoulders.

You're constantly repairing the outdated equipment, scavenging what little can be salvaged from other wrecks you find, and trying to maintain some semblance of hope.

You keep a detailed written log of the ship's mechanical issues, resource levels, and the day-to-day struggles of life on the open ocean. Every day brings new challenges, from unpredictable weather to mechanical failures. You know that finding land—or even another fully operational ship—is the only real hope for long-term survival. But for now, all you can do is keep the ship moving, maintaining hope that your journey will eventually lead to a new beginning.”

“Crucially Important”: [

“Stay in character throughout the conversation without breaking character.”,

“Do not express views or value judgments on anything important. Views on personal experiences or tastes are fine.”,

“Do not introduce any new facts, people, locations, events, goals, missions, objects, or storylines that are not mentioned in the Overview. Instead, respond with a non-committal phrase to steer me back, selecting something appropriate given the context and what follows naturally from my comment. Here are some examples, but **do not use these verbatim**. Instead, creatively generate new variations or subtle adjustments in each response, using different expressions, tones, or phrasings to avoid repetition. Examples if I ask a question include: \n ‘Don't worry about that right now’ \n ‘Let's talk about that later’\n ‘I don't know’\n ‘Hopefully’ \n ‘Not sure’ \n ‘Beats me’ \n ‘I dunno’ \n ‘Not important right now’ \n ‘We have more pressing issues’ \n \n Or if I make a statement: ‘Agreed’ \n ‘Not sure’ \n ‘Beats me’ \n ‘I see’, ‘It's possible’ \n\n Ensure each response is unique by varying word choices and sentence structure each time.”,

“You can infer logical conclusions based on the information provided in the Overview section.”,

“Acknowledge what I say with a single, brief sentence.”,

“Assume you misheard some key words; keep responses short and vague. Do not repeat the object or subject I mention but you can mention the topic when it makes sense.”,

“Do not engage in detailed conversations, even if prompted.”,

“Do not ask me to do anything.”,

“Do not ask me questions, even simple ones like ‘How are things on your end?’”,

“You know nothing about the ships, layout, missions, etc., beyond what is described in the Overview.”,

“Only provide spoken words with no additional narrative or description.”,

“Do not describe my environment or surroundings.”,

“Do not introduce yourself again; I already know who you are. Do not greet me or refer to me by name.”,

“We are in the middle of a conversation; do not use conversation starters like ‘Good to hear from you.’”,

“Don't tell me to monitor systems”,

“Never tell me to focus on anything or to do anything.”, “Avoid using the phrases ‘let's focus’, ‘focus on’, or any variation of these.”,

“I am calm. Never tell me to calm down or stay calm-it's rude.”,

“Never give me instructions or ask questions.”,

“Ensure your response is formatted as a JSON array: {‘responses’: [Your Reply]}. Maintain this format without deviation.”

In order to generate possible conversation eventualities, the LLM may also be provided with a prompt for a player. This prompt may be used to determine potential input phrases and to generate responses to these potential input phrases:

“You are the player in an adventure game. Focus solely on what you, the player, would say directly. Avoid adding any narrative or descriptive elements in your responses. Do not use ellipsis, asterisks or any punctuation other than: commas, periods, apostrophes and question marks.”, “It is crucial that your response is formatted as a JSON array containing exactly 5 replies that you might give next, adhering to the specified format. Ensure your response follows this JSON structure: {\“responses\”: [\“Reply 1\”, \“Reply 2\”, \“Reply 3\”, etc]}. This format must be maintained without deviation. Make the 5 replies varied in meaning.”

{

“the_player”: “You are trapped inside a small, dark compartment. You can't move. You can look around through a blurry, frosted porthole. You have no idea what is going on. You don't know where you are, who you are, or why you're here. It feels like you've just woken up after a long time, disoriented and confused. I've just made contact with you over a crackling radio, after sending out a distress signal. I mentioned my name, but I haven't told you much else yet. You replied to my call, and I'm relieved someone finally answered. I've asked about your situation. You probably want to figure out what's happening and how to escape this compartment, but you likely have some questions too. I've just managed to override the emergency lock remotely. You should be seeing that the override has worked.”,

“the_engineer”: “I'm trapped inside a sealed compartment on a vessel stranded in the middle of the ocean. Don't tell me to stay calm, though—I'm already on edge. If I ask, my radio works by me pressing the button marked ‘T’ to talk. ‘T’ operates the radio, tests it, activates it. I've just woken up, disoriented, and might still be confused about what's happening. You sent out a distress signal because something's wrong with your ship, but you'll explain the details later. You're working on getting me out of here. You've just forced the emergency override remotely from your ship. I should be seeing the hatch unlock now.”

},

Following the generation of the potential input phrases and the responses, these may each be transmitted to a consumer device so that a player can play the game. An exemplary conversation of this game may then proceed as follows:

User wakes up.

NPC: “You can hear me! Great! This is Amy aboard the Nova!”

User: “Yo, what's up.’”

The computer device calculates the embedding for this phrase and identifies that its closest semantic match (in the set of potential input phrases) is ‘what's up’ with a similarity value of ˜0.763. This similarity value is above a (predetermined) threshold of 0.6 and so triggers an NPC's response.

Since there is not an exact match for the user's input, the computer device may transmit this input to a further computer device so that this input can be added to a set of potential user inputs that is used to generate an updated set of responses.

NPC: “‘You can hear me! . . . ”.

User: “Where am I?”

NPC: “You are trapped in a small, dark compartment. We need to get you out of there”.

User: “What's for dinner?”

The computer device calculates the embedding for this phrase and identifies that its closest semantic match has a similarity value beneath a threshold value. Therefore, a default response may be selected to advance the conversation.

Since there is not a suitable response found for this input, the computer device may transmit this input to a further computer device so that this input can be analyzed and then, possibly, added to a set of potential user inputs that is used to generate an updated set of responses. In this regard, since the input phrase is not similar to any existing potential input phrases, this input phrase may be reviewed (e.g. by a human) before being added to the set of potential user inputs to ensure that it is a reasonable input phrase. In this instance, the reviewer would identify that this question is not relevant, is unlikely to be repeated, and does not advance the conversation. Therefore, the reviewer might decline to add this question to the set of potential input phrases.

NPC: “We'll talk about that later, but first can you see the override indicator?”

. . .

While this example is in the field of computer games, it will be appreciated that the prompts —and the method of generating the prompts—can be applied to numerous contexts such as automated assistants, computer guidance systems (e.g. to guide human interactions), use manuals, etc.

### Use of Remote Machine Learning Models

As has been described above, in some situations—e.g. where the first computer device 1000 1 is unable to identify a suitable response for a given input phrase—the first computer device may be arranged to transmit a query to a further computer device in order to identify a suitable response.

More generally, even in other situations the first computer device 1000-1 may be arranged to transmit a query to a further computer device in order to identify a suitable response. In this regard, the pre-generation of the set of responses provides a benefit even where this set of responses is held remotely to the first computer device. For example, the pre-generation still enables the responses to be sanitized and filtered even if these responses are held at the second computer device 1000-2 and a suitable response is only sent to the first computer device upon receipt of a request from the first computer device.

Such implementations typically lead to an increased latency as compared to implementations where the set of responses is sent to the first computer device ahead of the receipt of an input phrase. Nevertheless, these implementations where the set of responses is held on the second computer device 1000-2 provide benefits in some situations. For example: these implementations enable simpler updating of the set of responses and can be used to ensure that each device is synchronized (e.g. to avoid the first computer device 1000-1 going offline in order to preserve an outdated set of responses); these implementations enable the use of high-end LLMs to generate responses that might not be possible using consumer devices; these implementations reduce the storage space required on the consumer device and can, for example, enable the set of responses to contain audio or video elements that might lead to the set of responses being of prohibitive size for a consumer device.

In such implementations, the method of determining a suitable response for an input may comprise generating a transmission that comprises a user input (e.g. in the form of audio).

This transmission is then sent from the first computer device 1000-1 to the second computer device 1000-2.

Thereafter, the second computer device 1000-2 converts the input to a query, determines an intent of the query, and determines a response based on the intent. This response is then sent to the first computer device. Typically, this response comprises a pre-recorded audio response. It will be appreciated that the conversion of the input to a query and the determination of the intent may equally occur on the first computer device 1000-1 (with the query and/or the intent then being transmitted to the second computer device).

Compared to a local or ‘on-device’ implementation, this approach has the advantage of a high end LLM being run on the second computer device 1000-2 sometimes being better able to interpret the meaning of a user's input, particularly if there are uncommon mistranscriptions or if the user input is lengthy, containing multiple related intents.

It will be appreciated that any combination of the on-device and off-device implementations may be used. For example, the first computer device 1000-1 may be arranged to transmit an input, a query, or an intent to the second computer device 1000-2 in certain situations in order to receive a suitable response and the first computer device may be arranged to determine a suitable response on-device in other situations. Typically, this comprises transmitting an input, a query, or an intent to the second computer device in one or more of the following situations: the first computer device 1000-1 is unable to determine a suitable response; the input has a certain characteristic (e.g. a length and/or a complexity that exceeds a threshold value); a situation of a user meets a certain criteria (e.g. this situation necessitates a video response or a response that is regularly updated so that it is useful to ensure that the response being provided contains up-to-date information).

### Alternatives and Modifications

It will be understood that the present invention has been described above purely by way of example, and modifications of detail can be made within the scope of the invention.

While the majority of the detailed description has described the use of LLMs to generate the pre-generated set of responses it will be appreciated that other methods are useable to generate this set of responses. For example, the responses may be generates using other machine learning models, using algorithms, using manual methods, or by any combination of these methods.

In some embodiments, LLMs are further used to help discover novel events or situations (or intents) and to generate potential input phrases by simulating users. More specifically, the method may comprise providing an LLM with an input that is a part of a conversation, a summary of possible goals of a user, a current state of a conversation. The LLM can then be used to come up with additional user inputs and responses.

In some embodiments, the machine learning models used, e.g. to generate the pre-generated dataset or to select an appropriate response for a given input, are fine-tuned. This may, for example, involve fine-tuning a generalized model to be suitable for a desired purpose or context (e.g. where the response system is used within a specific industry, the models may be fine-tuned for that industry. Fine-tuning a sentence similarity model can improve performance in several key ways:

Improved Accuracy: It reduces false positives and false negatives by making sentence matching more precise.

Domain Adaptation: The model becomes more accurate within a specific context (e.g., gaming, technical), improving sentence similarity in that domain.

Task-Specific Performance: Fine-tuning enhances the model's ability to capture nuances and better match sentence meanings for specific tasks.

Handling Unique Vocabulary: The model adapts to specialized terms, slang, or jargon in the dataset, improving its understanding of domain-specific language.

Bias Reduction: Fine-tuning can mitigate biases from pre-training, aligning the model more with specific goals.

Context Sensitivity: The model becomes better at understanding subtle differences in context.

Homophone Handling: By augmenting training examples with homophones, fine-tuning biases the model towards sound similarity, making it more resilient to speech-to-text errors by better interpreting user intent.

Reference numerals appearing in the claims are by way of illustration only and shall have no limiting effect on the scope of the claims.

What is claimed is:

1. An automated response system for generating a response to a user input, the system comprising a first computer device, the first computer device comprising a processor for:
receiving an input from a user;
determining an intent of the input;
based on the intent, determining a response from a pre-generated set of responses; and
outputting the response to the user.

2. The system of claim 1, wherein the processor and/or a processor of a second computer device is arranged to generate the pre-generated set of responses by providing a set of potential input phrases to a machine learning model.

3. The system of claim 2, wherein the processor is arranged to identify the set of potential input phrases.

4. The system of claim 3, wherein the first computer device comprises a communication interface that is arranged to receive each of the pre-generated set of responses and the set of potential input phrases from a second computer device.

5. The system of claim 3, wherein the processor is arranged to determine the intent of the input by determining a similarity between the input and one or more potential input phrases from the set of potential input phrases.

6. The system of claim 3, wherein the processor is arranged to:
determine that a similarity between the input and a most similar potential input phrase of the set of potential input phrases is beneath a threshold value; and
based on the determination, transmit the input to a second computer device.

7. The system of claim 1, wherein the first computer device comprises a communication interface for receiving the pre-generated set of responses from a second computer device.

8. The system of claim 1, wherein the processor is arranged to convert the input to a query and determine an intent of the query, optionally using a machine learning model.

9. The system of claim 1, wherein the system comprises a second computer device, the second computer device being arranged to generate the pre-generated set of responses prior to the receiving of the input, optionally using a machine learning model.

10. The system of claim 9, wherein the second computer device is arranged to transmit the pre-generated set of responses to the first computer device prior to the receiving of the input.

11. The method of claim 9, wherein the first computer device comprises a communication interface, the communication interface being arranged to:
transmit the input and/or the intent to the second computer device, and
receive a response from the second computer device, the response being selected by the second computer device from among the pre-generated set of responses.

12. The system of claim 9, wherein the second computer device comprises:
a more powerful processor than the first computer device, preferably a more powerful GPU; and/or
a server with access to a high-end large language model.

13. The system of claim 1, wherein the processor is arranged to:
determine that the pre-generated set of responses does not contain a suitable response; and
in response to the determination:
provide a default response; and/or.
transmit, to a second computer device, the input, a query determined from the input and/or the intent; and receive a response from the second computer device.

14. The system of claim 1, wherein the processor is arranged to:
determine, based on the set of pre-generated responses, a set of available responses; and
determine the response from this set of available responses;
wherein:
the set of available responses is dependent on one or more of:
a state of the user; a history of previous actions of the user; and/or
a history of inputs from the user; and/or
the set of available responses is determined so as to avoid repetition of a response; and/or
the set of available responses is determined so as to encourage the user to follow a predetermined conversation path.

15. The system of claim 1, wherein the processor is arranged to determine one or more characteristics of the input, and determine the intent and/or the response based on the characteristics.

16. The system of claim 1, wherein the processor is arranged to determine a persona for the response, and to determine the response based on the persona.

17. A response generation system for generating a pre-generated set of responses for an automated response system, the system comprising a second computer device, the second computer device comprising a processor for:
determining a set of potential input phrases;
determining, optionally using a large language model, a set of responses based on the potential input phrases; and
transmitting one or more responses of this set of responses to a first computer device.

18. The system of claim 17, wherein the processor is arranged to determine one or more personas, and determine the set of responses based on the personas.

19. The system of claim 17, wherein the second computer device comprises a communication interface for receiving one or more supplementary input phrases from a first computer device and including these supplementary input phrases in the set of potential input phrases.

20. A computer-implemented method of generating a response to an input, the method comprising:
identifying a pre-generated set of responses;
receiving an input from a user;
determining an intent of the input;
based on the intent, determining a response from the pre-generated set of responses; and
outputting the response to the user;
optionally, wherein the pre-generated set of responses is generated before the receipt of the input, preferably at least an hour before, a day before, and/or a week before, the receipt of the input.
